(19) United States
(12) Patent Application Publication
(10) Pub. No.: US 2010/0059360 A1
(43) Pub. Date: Mar. 11, 2010

(54) Method For The Production Of Nanoparticles

(76) Inventor: Thomas Wendling, Munich (DE)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/302,957

(22) PCT Filed: Jun. 4, 2007
(86) PCT No.: PCT/EP2007/055473

§ 371 Date: Sep. 23, 2009

(30) Foreign Application Priority Data
Jun. 2, 2006 (EP) 06011485.7

(51) Int. Cl. B01J 19/08; B01J 19/12; B01J 19/10

(52) U.S. Cl. 204/156; 204/157.15; 422/186; 977/899; 977/773

(57) ABSTRACT

The present invention relates to methods for the production of nanoparticles which may be optionally coated. In particular, the present invention relates to methods for the production of nanoparticles characterized in that precursors are subjected to substantially the same amount of activation energy or combination of activation energies in the activation zone at a predetermined concentration of precursors and at a predetermined time of exposure to the activation energy/energies. Furthermore, the present invention relates to nanoparticles produced by the methods according to the present invention. Finally, the present invention concerns a device for producing nanoparticles according to the method of the present invention. The invention provides for a tighter particle size distribution of the generated nanoparticles. The activation energy is selected from the group of RF, MW, IR, plasma, heat and photon absorption.

### FIELD OF THE INVENTION

The present invention relates to methods for the production of nanoparticles which may be optionally coated. In particular, the present invention relates to methods for the production of nanoparticles characterized in that precursors are subjected to substantially the same amount of activation energy in the activation zone at a predetermined concentration of precursors and at a predetermined time of exposure to the activation energy. Furthermore, the present invention relates to nanoparticles produced by the methods according to the present invention. Finally, the present invention concerns a device to produce nanoparticles according to the method of the present invention.

### BACKGROUND

Nanoparticles normally comprise particles of chemical elements, such as carbon, silicon, gold, iron etc. or particles of simple compounds such as silicon-germanium compounds, aluminium oxides, silicon-nitrides, nickel-selenide, lead-telluride, GaₓAs_{y}, InₓGa_{y}As_{z}, ZnO, etc. as well as particles that form agglomerates of two or more compounds, like Si/C/N, Si₃N₄/SiC, etc.

A nanoparticle is a nanoscopic particle whose size is measured in nanometers (nm). It is defined as a particle with at least one dimension <100 nm. Nanoparticles made of semiconducting material may also be labeled quantum dots if they are small enough (typically sub 10 nm) so that quantization of electronic energy levels occurs. Nanoparticles are of great scientific and engineering interest as they are effectively a bridge between bulk materials and atomic or molecular structures. A bulk material should have constant physical properties regardless of its size, but at the nano-scale this is often not the case. Size-dependent properties are observed such as quantum confinement in semiconductor particles, surface plasmon resonance in some metal particles and superparamagnetism in magnetic materials. (Semi)-solid and soft nanoparticles have been manufactured. A prototype nanoparticle of semi-solid nature is the liposome. The properties of materials change as their size approaches the nanoscale. For example, the bending of bulk copper (wire, ribbon, etc.) occurs with movement of copper atoms/clusters at about the 50 nm scale. Copper nanoparticles smaller than 50 nm are considered super hard materials that do not exhibit the same malleability and ductility as bulk copper. The interesting and sometimes unexpected properties of nanoparticles are partly due to the aspects of the surface of the material dominating the properties in lieu of the bulk properties due to the large surface/bulk ratios. The percentage of atoms at the surface of a material becomes significant as the size of that material approaches the nanoscale. For bulk materials larger than one micrometer the percentage of atoms at the surface is minuscule relative to the total number of atoms of the material. Suspensions of nanoparticles are possible because the interaction of the particle surface with the solvent is strong enough to overcome differences in density, which usually result in a material either sinking or floating in a liquid. Nanoparticles often have unexpected visible properties because they are small enough to scatter/shift visible light rather than absorb it or they show fluorescent behavior the bulk material does not show. For example gold nanoparticles appear deep red to black in solution. Metal, dielectric, and semiconductor nanoparticles have been formed, as well as hybrid structures (e.g., core-shell nanoparticles). Nanospheres, nanorods, and nanocups are just a few of the shapes that have been grown. Semiconductor quantum dots and nanocrystals are types of nanoparticles. Such nanoscale particles are used in biomedical applications as drug carriers or imaging agents. Various types of liposome nanoparticles are currently used clinically as delivery systems for anticancer drugs and vaccines. Nanoparticle characterization is necessary to establish understanding and control of nanoparticle synthesis and applications. Characterization is done by using a variety of different techniques, mainly drawn from materials science. Common techniques are electron microscopy [TEM,SEM], scanning tunneling microscopy (STM), atomic force microscopy [AFM], x-ray photoelectron spectroscopy [XPS], powder x-ray diffractometry [XRD], Raman-spectroscopy and Fourier transform infrared spectroscopy [FTIR]. Besides research purposes, nanoparticles have already been used for commercial purposes. Refrigerators and washing machines that are able to release silver nanoparticles that enable the machines to kill micro-organisms, as the silver nanoparticles inhibit the respiration of the micro-organisms and suffocate them. This ensures that food will stay fresh for a very long time and clothes are cleaned thoroughly. Nanoparticle research is currently an area of intense scientific research, due to a wide variety of potential applications in biomedical, optical, and electronic fields. The National Nanotechnology Initiative of the United States government has driven huge amounts of state funding exclusively for nanoparticle research.

Thus, today and in the future nanoparticles find and will find broad applications in a variety of fields. For example, application of nanoparticles is known in the field of cosmetics, coatings, electronics, polishing and catalysis. In addition, nanoparticles are used in the field of semiconductors, e.g. silicon nanoparticles which are of special interest to the industry in view of their potential uses in photoluminescence based devices, doped electroluminescence light emitters, memory devices and other microelectronic devices, such as diodes and resistors. Another field for the application of nanoparticles is their use in coating systems, like varnishes or paints, especially as pigments in said systems, in particular for hardened an self-cleaning systems. Finally, application of nanoparticles is described in the field of pharmaceutical products, fertilizers, pesticides and the like.

Nanoparticles can be produced by different methods. Conventional methods used to prepare nanoparticles include pyrolysis, reaction in the gas phase, crystallization, precipitation, the spray method and the like under conditions of nucleation of the precursors in the zone of reaction, in the following sometimes also referred to as nanoparticles generation zone or activation zone. For example, the synthesis using the physical vapour synthesis method comprises the step of sputtering, thermalisation and clustering. In the sputtering step, a solid precursor is fragmented to molecular size particles, which comprise a high temperature of a vapour of the aforementioned precursor material. In the thermalisation step, a reactant is added to the vapour, which is then cooled at a controlled rate and condenses at the clustering step to form nanoparticles.

Another known method to produce nanoparticles is a technique using arc energy. This technique allows using a wide variety of precursor formats and chemical composition, thus, expanding the number of materials that can be manufactured as nanopowders at industrial scale.

Another example for a method for the generation of nanoparticles is a Laser Ablation of Microparticles (LAM) process, which is used for making nanoparticles of a wide variety of materials. In the LAM process, a high-energy Laser pulse hits a microparticle, larger than 1 μm in size or a solid initiating a breakdown and shockwawe formation. As the shock passes through the microparticle or solid, it converts a high percentage of the mass to nanoparticles. The Laser ablation method results in nanoparticles with a better controllable diameter and a small dispersion compared to particles generated by the methods described above. The LAM method claims a particle size deviation of 20% or less in comparison to other methods. However, the LAM method is economically unfavourable due to the low efficiency.

Another method for the production of nanoparticles is simply milling larger particles. However, milling the larger entities to obtain nanoparticles necessitates subsequent classification of the generated nanoparticles. Finally, pyrolysis is applied to generate nanoparticles. More precisely, the precursor is pyrolyzed in a reactor to grow nanoparticles. This method is also relatively simple. However, the sizes of the nanoparticles are dependent on a concentration of the precursor, and the concentration of the precursor must be low in order to prepare small sized nanoparticles. Thus, when using pyrolysis, a small number of nanoparticles are produced due to a low concentration of the precursor.

Obviously, high production rate, unagglomerated particles and narrow particle size distribution are at odds in the classical processes of gas phase synthesis. A high production rate is obtained only with high particle density in the gas stream and a high particle density provokes particle agglomeration. Further, to avoid sintering of the agglomerates, it is necessary to work at the lowest possible temperature where kinetic obstacles prevent the chemical reaction. To obtain the necessary high temperature in the fast flowing reaction gas, a relatively long residence time at elevated temperature is necessary and this leads to a wide particles size distribution. Another way to avoid sintering of the particles is to coat the nanoparticles.

In the art, the use of a resonant microwave plasma process has been suggested to solve the above problems known from gas condensation processes. Association and ionization of the reactants should allegedly remove the kinetic obstacles and reduces the reaction temperature significantly. E.g. in DE 196 38 601 and DE 102 03 907 processes are described using the microwave plasma technique for synthesizing various nanostructured particles. However, the nanoparticles produced by applying microwave plasma still suffers from a wide distribution of nanoparticles sizes and, therefore, require to apply expensive methods to select particles of the desired size. Further, the technique is limited to certain reactions and can be applied in the gas phase reaction only.

The Vollath system as described in the above mentioned documents is based on a resonating microwave system, which can be highly non-uniform, see e.g. FIG. 1, especially when the system has the same dimensions as the reactor, which is the case in the mentioned patent. This is contrary to the gist of the present invention, as the particles would not experience a uniform activation energy exposure over a predetermined time, namely the time in the activation zone. The intensity and the electromagnetic field strength in the center of the Vollath resonator will be stronger than at the perifery of the activation zone.

Hence, an object of the present invention is to provide a method allowing the synthesis of nanoparticles with a narrow particle size distribution which would preferably make any classification of the obtained nanoparticles redundant.

A further objection of the present invention is the provision of nanoparticles having a very narrow particle size distribution as well as a device to produce the same.

### SUMMARY OF THE INVENTION

The present invention provides a method for producing nanoparticles which have a very narrow size distribution and are preferably uniform in size, said method comprises the step of forming nanoparticles in an activation zone of a reactor from precursors by applying activation energy, of a single type or a combination of types of activation energy, thereto. Said precursors are activated in an activation zone of said reactor for a predetermined time and/or velocity at a predetermined concentration of the precursors, wherein the method of the present invention is characterized in that the amount of activation energy over the time when passing the activation zone is substantially the same for the precursors.

The amount activation energy may be applied by means of a single type of energy, e.g. electromagnetic waves. In a preferred embodiment of the invention, the amount of activation energy is applied by combining at least two types of activation energy. Over the time when the precursors pass the activation zone, the at least two types of activation energy in combination apply substantially the same amount of activation energy to all precursors. The at least two types of activation energy may be applied simultaneously and/or subsequently to the precursors.

Preferably, the types of activation energy are selected from the group of electromagnetic waves, RF (preferably RF plasma), MW (preferably MW plasma), IR (preferably IR plasma), heat, photo absorption or activation, or plasma by electric discharge, radioactive radiation and sonar energy. The term electromagnetic waves may be one or more types of electromagnetic waves, e.g. γ-rays, x-rays, ultra violet (UV) waves, visible light waves, infrared waves, microwaves (MW) and radio frequency (RF) waves.

The activation energy may be introduced into the activation zone for example with electromagnetic waves. The activation energy may be introduced into the activation zone for example with a combination of heat and other electromagnetic waves. The activation energy may be introduced into the activation zone for example with a combination of heat, sonar waves and electromagnetic waves. The activation energy may be introduced into the activation zone for example with a combination of heat and sonar waves. The activation energy may be introduced into the activation zone for example with a combination of heat and radioactive radiation etc. In other words: All the combinations of the cited types of energy are possible.

The present inventor suggests that in order to obtain nanoparticles uniform in size distribution the activation energy, i.e. the energy density in the activation zone must be uniform and constant over the time the particles are exposed to it in order to produce said mono-dispersed nanoparticles. In particular in the case of a uniform flow or a stagnant fluid, the energy density perpendicular to the introduced electronic waves is substantially uniform, to ensure that precursors in the center of and at the periphery of the activation zone are subjected to the same amount of activation energy. Equally if the flow is not uniform, measures have to be taken to compensate in energy distribution for the nonuniform flows as is described later.

In one embodiment of the present invention, the flow of the precursor through the activation zone is constant, thus, the retention time of the precursors in the activation zone is constant.

The flow of the precursor through the activation zone is not necessarily constant, but it could be for example parabolic as is for example the case for viscous flow. In a preferred embodiment of the invention, the spatial power density distribution of at least one type of activation energy in the activation zone is non-uniform in order to at least partially compensate for a non-uniform spatial distribution of the flow velocities of the precursors. Preferably the combined spatial power density distribution of two or more types of activation energy is non-uniform in order to at least partially compensate for a non-uniform spatial distribution of the flow velocities of the precursors. With this embodiment of the invention it can be achieved that a lower (combined) amount activation energy in the area with a lower flow velocity compensates for the higher (combined) amount activation energy in the area with a higher flow velocity so that the amount of activation energy over the time when passing the activation zone is substantially the same for all precursors.

The preferred spatial power density distribution of at least one type of activation energy integrated over the length of the activation zone is essentially a parabolic, at least almost a Gaussian, or at least almost a spherical function of the distance from the center. More preferably, the combined spatial power density distribution of two or more types of activation energy is essentially a parabolic, at least almost a Gaussian, or at least almost a spherical function of the distance from the center. With this embodiment of the invention it can be achieved that a spatial distribution of the velocity of precursors that is essentially a parabolic function with respect to the center of the tube, can be compensated for quite accurately. The preferred activation zone is essentially tubular. Preferably, the flow of the precursors through the activation zone is a viscous flow. It is achievable with this embodiment of the invention that the spatial distribution of the velocity of precursors is essentially a parabolic function of the distance from the center of the tube.

In a preferred embodiment of the invention at least part, preferably all, of the amount of activation energy is applied by means of a beam of electromagnetic waves, e.g. a Laser beam, that propagate in a direction essentially parallel or/and anti-parallel to direction of flow of the precursors. This way, the intensity profile of the electromagnetic waves in the plane perpendicular to the direction of propagation can be chosen to at least partially compensate for a velocity profile of the precursors in a plane perpendicular to the direction of flow of the precursors. Preferably, the electromagnetic waves have an essentially partial Gaussian intensity profile. If one cuts of the edges of a Gaussian profile, it is very close to a parabolic profile. Similarily, if one chooses a spherical profile it is very similar to a parabolic profile if one does not go too far to the edge of the sphere. Such a profile can e.g. easily be achieved in a Laser beam. Alternatively, they may e.g. have a Gaussian, or spherical intensity profile. With all these profiles, it is possible to quite accurately compensate for an essentially parabolic flow profile of precursors.

In a preferred embodiment of the invention at least part of the amount of activation energy is applied by means of a beam of electromagnetic waves, e.g. a Laser beam, being focused on a center line of the activation zone. Thereby, it can be achieved that the diameter of the beam varies linearly along the center line, which results into a variation parabolic with the distance from the center line of the intensity of the electromagnetic waves integrated over the length of the activation zone. With this parabolic profile an essentially parabolic flow profile of precursors can quite accurately be compensated for. In this embodiment of the invention, the intensity distribution of the beam perpendicular to its direction of propagation is preferably uniform.

In a preferred embodiment of the invention at least part of the amount of activation energy is applied by means of a spherical plasma in the activation zone. Preferred plasmas include radio frequency (RF) and microwave (MW) plasmas. The plasma is generated preferably by resonance. With a spherical plasma, an essentially parabolic flow profile of precursors can quite accurately be compensated for. The activation zone can comprise more than one plasma.

Alternatively to or in combination with the non-uniform spatial distribution of the activation power density in the activation zone, diffusion of the precursors in the activation zone can be exploited to ensure that all precursors are exposed to essentially the same amount of activation energy during their journey though the activation zone. In a preferred embodiment of the present invention, the flow velocities and/or the mean free path of the precursors are chosen so that the precursors diffuse far enough while in the activation zone, to at least partially compensate for a non-uniform spatial distribution of the flow velocities of the precursors and to compensate for a non-uniform intensity of the activation energy. The diffusion length can be influenced according to the laws of physics by pressure and temperature.

In another embodiment of the present invention the method is characterized in that the unit for providing the activation energy is relatively movable to the area/volume where the nanoparticles are generated. In particular, the unit for providing the activation energy is moved with a constant velocity and constant width through the stagnant layer of precursors.

The present invention may be applied to fluids, containing the precursors. That is, in the method according to the present invention, the precursors may be present in a gas phase or may be present in a liquid phase. The precursors may be (suspended) solids, liquids or gases. Alternatively, the precursors might be present in solids, e.g.

microporous material, like zeolite, polycrystalline materials such as polysilicon etc. Thus, solids like catalysts may be prepared containing nanoparticles.

In a preferred embodiment for generating coated nanoparticles, the method comprises to expose the nanoparticles obtained after the first activation zone to a second activation zone to apply a coating to the nanoparticles.

For example, the precursor(s) for coating the nanoparticles may be supplied to the nanoparticles obtained after the first activation zone through a supply arranged downstream from the first activation zone and upstream of the second activation zone. In another embodiment, the precursors for the coating are already present from the start but activated with a different amount or type of activation energy or with a different combination of types of activation energy in a 2nd zone downstream from the particle nucleation and growth zone.

In some embodiments, the activation energy or one of the two or more types of activation energy are pulsed for a predetermined time or a predetermined sequence and with a predetermined energy in the activation zone. Preferably, the duration of the pulse of activation energy is chosen so that a transport of the precursors during the pulse time does not exceed 1/10 of the width of the part of the activation zone affected by the pulse of activation energy, the width measured in the direction of the fastest flow.

Nanoparticles produced by the methods according to the present invention are characterized in that the particle size of said nanoparticles exhibits deviations of less than 10% from the mean size (RMS), like less than 5% deviation in size, for at least 95% of the produced nanoparticles. Preferably, the particle size distribution is less then 5% deviation in 95% of the produced nanoparticles.

The device according to the present invention allows the production of nanoparticles according to the method of the present invention.

### BRIEF DESCRIPTION OF THE DRAWINGS

FIG. 1: FIG. 1 shows the particle size distribution of two different types of nanoparticles obtained with the microwave plasma system as described by Vollath et al, e. g. in DE 196 38 601 and DE 102 03 907 As can be seen from FIG. 1, nanoparticles with a broad particle size distribution have been obtained.

FIG. 2: FIG. 2 is a schematic flow chart showing a first embodiment of the present invention.

FIG. 3: FIG. 3 shows a schematic flow chart for a liquid based carrier system.

FIG. 4: FIG. 4 is a schematic flow chart showing another embodiment of the present invention. In particular, FIG. 4 provides a flow chart showing an embodiment wherein the unit for providing the activation energy is movable over a stagnant or moving precursor.

FIG. 5: FIG. 5 provides a schematic flow chart of another embodiment of the present invention showing a method for providing coated nanoparticles. FIG. 5 shows an embodiment having two activation zones where in the first activation zone nanoparticles are generated while in the second generation zone said nanoparticles are coated with precursor molecules introduced to the generated nanoparticles.

FIG. 6: FIG. 6 is a schematic flow chart showing the embodiment for a method using a pulsed system.

FIG. 7: FIG. 7 schematically shows a device for the production of nanoparticles according to the present invention. FIG. 8: FIG. 8 schematically shows a device for the production of nanoparticles according to one embodiment of the present invention with combined thermal and Laser activation energies.

FIG. 9: FIG. 9 schematically shows a device for the production of nanoparticles according to another embodiment of the present invention.

FIG. 10: FIG. 10 schematically shows a device for the production of nanoparticles according to yet a further embodiment the present invention.

FIG. 11: FIG. 11 schematically shows an example of a device for the production of nanoparticles according to the present invention with two pulsed Lasers.

FIG. 12: FIG. 12 schematically shows an example of a device for the production of nanoparticles according to the present invention with a pulsed Laser.

FIG. 13: FIG. 13 schematically shows another example of a device for the production of nanoparticles according to the present invention with a pulsed Laser.

FIG. 14: FIG. 14 schematically shows another example of a device for the production of nanoparticles according to the present invention with a pulsed Laser, where the laser is movable.

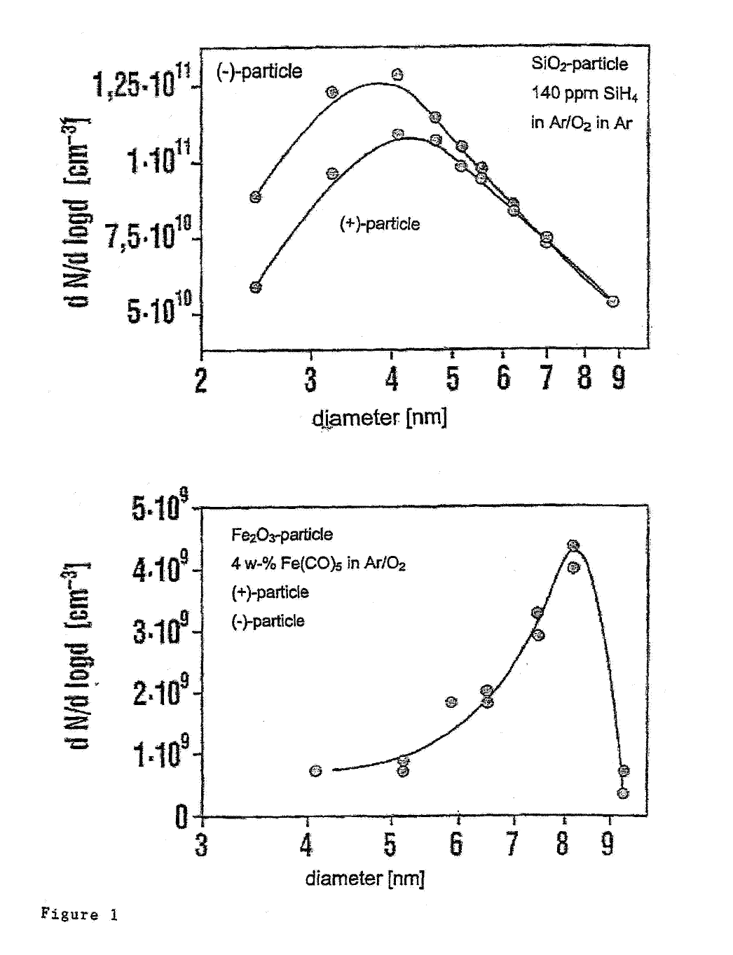

### DETAILED DESCRIPTION

The following description of particular embodiments is offered by way of illustration and not by way of limitation. Unless contraindicated or noted otherwise herein, the terms “a” and “an” mean one or more, the term “and/or” herein includes the meaning of “and”, “or” and “all or any other combination of the elements connected by said term”.

The following definitions are set forth to illustrate and define the meaning and scope of the various terms used to describe the invention herein.

“Activation zone” refers to the area where the precursors are activated by applying activation energy, e.g. in form of electromagnetic waves to said precursors. Typically, but not necessarily, the activation zone is present in a reactor or device. The activation zone can be the zone, where the nanoparticles nucleate, grow or/and are coated.

“Electromagnetic wave” refers to the full electromagnetic spectrum with wavelength of several hundred meters to several nanometers. Further, the use of electromagnetic waves may be accompanied by additional heat to promote diffusion of the precursors to the growing nanoparticles. Heat may also serve to elevate the energy to a level, where the additional activation energy from e.g. electromagnetic waves suffices to accomplish the chemical reaction for the nucleation and growth of the nanoparticles. Further, the use of electromagnetic waves may be accompanied by additional sonar or other energy to promote diffusion of the precursors to the growing nanoparticles. Sonar and other energies may also serve to elevate the energy to a level, where the additional activation energy from e.g. electromagnetic waves suffices to accomplish the chemical reaction for the nucleation and growth of the nanoparticles. All the combinations of the cited types of energy are possible.

“Substantially uniform” or “substantially homogenous” as used herein refers to a state where the referenced parameter is identical or deviates barely detectable. In other words, the precursors, nanoparticles and/or coatings receive the same amount of activation energy during the transition through the activation zone. There should be no substantial nonuniformities as we experience them for example in the microwave plasma resonator generation system of DE 196 38 601. That is, the total energy density the particles experience on their way through the activation zone is uniform.

The present invention relates to methods for the production of nanoparticles. In this connection, nanoparticle is a nanoscopic/small particle whose size is measured in nanometers (nm). It is defined as a particle with at least one dimension <100 nm, usually of the order of 1 to several 10 nm.

In particular, the present invention overcomes the problems known in the art for providing nanoparticles having a narrow size distribution without applying a further cost-intensive and laborious size dependent separation process.

According to the present invention, nanoparticles may be produced using a method comprising the step of forming nanoparticles in a reactor from precursors by applying activation energy thereto. Said precursors being activated in an activation zone of said reactor for a predetermined time at a predetermined concentration of the precursors characterized in that the amount of activation energy over the time when passing the activation zone is substantially the same for the precursors. That is, the present inventor recognized that it is essential to subject all precursors to substantially the same activation energy when passing the activation zone in order to obtain nanoparticles having a narrow particle distribution. For example, the energy density may be substantially identical in the whole activation zone. However, it is also possible that the energy density or the activation energy decreases from the portion where the electromagnetic waves for providing the activation energy or part of the activation energy are impinged in the activation zone to the area where the electromagnetic waves leaves the activation zone. Both systems are possible according to the present invention as long as the amount of activation energy supplied to all precursors is substantially the same.

The present inventor found that a drawback of the systems known in the art for producing nanoparticles lies in the inhomogeneity of the activation energy in the activation zone. For example, in the system as described by Vollath et al, e.g. in DE 196 38 601, the energy is provided substantially non-uniform since said is based on a resonating microwave system. This is especially true, when the system has the same dimensions as the reactor, which is the case in the above mentioned patent document. This negatively influences the particle size distribution of the obtained nanoparticles since the particles would not experience a uniform activation energy exposure over a predetermined time, namely the time in the activation zone. This system requires a low pressure and a long mean free path so that particles statistically receive some low energy at the periphery of the tubing and higher energy at the center of the tubing in order to receive approximately the same energy during the transition through the system. This method could not be applied at higher pressures or in liquids such as water or alcohol etc.

Using a resonator results in the generation of standing waves in the system, as described e.g. in DE 196 38 601. This is done by Vollath in the above mentioned system since the activation zone has dimensions similar to the wave length of microwave system. Standing waves are not excluded in the present invention, however, such a resonating system has a nonuniform energy density distribution. This nonuniform energy density distribution requires either an adjustment of flow velocity in order to expose each volume element with precursors to the same activation energy dose during the transition though the activation zone. Alternatively a low pressure with a long mean free path for the precursors is required in order to statistically expose each precursor to the same amount of low and high activation energy.

E.g. to increase the mean free path of molecules in a gas, the pressure has to be reduced. For a mean free path of the order of cm, which is required to compensate the nonuniformity of a microwave plasma a pressure of 1 Pa and a temperature between 400 and 500° C. is required, which requires an expensive vacuum system.

Further, according to the present invention it is possible to use traveling waves (non resonating waves) which is especially preferred in the case of the Laser or other light sources, which can generate uniform activation zones in gases, liquids and solids alike.

For example, the wavelength of an industrial RF plasma is approximately 22 m for the typically frequency of f=13.56 MHz. This length is relatively large with respect to a reaction chamber normally used for the preparation of nanoparticles, which has typical sizes of up to several 10 cm. Therefore the uniformity of the plasma over the defining length d in said reactor is independent of the wavelength. The uniformity is only influenced by minor peripheral nonuniformities due to reactor and electrode- or coil configuration, that is, the plasma is substantially uniform. This plasma uniformity is decisive for the particle size and its coating thickness.

In contrast, microwave frequencies for commercial permissible plasmas of 0.915 GHz or 2.45 GHz have wavelength of about 32 cm and 12 cm, which results in variations of the plasma intensity and power over the defining reactor dimensions and activation zone having typical sizes of up to several 10 cm. Together with the edge effects of the plasma, these plasma intensity fluctuations along the activation zone significantly influence the uniformity of nanoparticles and/or their coatings.

The activation energy contributed by Lasers or light can be applied by photon absorption or activation and does not necessarily require a plasma. In this case not only the intensity, which is controlled optically but also the wavelength itself contribute the activation energy and influence the chemical reaction. With the present invention the reaction can take place in gases, fluids and solids and the uniformity of the light beam only depends on the optics and the absorption. (“Light” is not restricted to the visible wavelengths but extends beyond the infrared and the ultraviolet regime to the complete electromagnetic spectrum.) The absorption of the light beam can be controlled by optical means, by applications of the beam from both/all sides or by keeping the activation zone narrow in relation to the absorption length of the light. The beam may also be introduced along the flow of the precursors as is shown in some embodiments of this invention. If there is absorption along the way, it affects all precursors the same. The activation may also depend on the wavelength of the light which is determined by the (Photon)light/Laser source chosen.

In case a resonant Laser beam is used to generate plasma, the energy density would only fluctuate for standing waves with half the wavelength and in the order of say 50 nm to several 100 nm. The length of the mean free path of a gas/ion molecule for standard (1 bar, 273.15K) conditions is of the same magnitude or larger. Therefore local non-uniformities are immediately compensated by the atomic/molecular/ionic movements. Again the nanoparticle size and coating thickness are determined by the exact lengths over which the Laser/light beam is applied to generate the plasma and to contribute the activation energy. The average plasma density can be made very uniform by optical means.

For dc-plasma the plasma uniformity is not influenced by a wavelength. In this case the reactor and electrode configuration and of course the chemistry and the partial pressures determine the plasma uniformity along the activation zone, which determine the size of the nanoparticles and their coatings.

According to a preferred embodiment of the present invention, the unit for providing the activation energy could be a RF source, a microwave source, a light source such as an excimer-pumped dye Laser (for example an XeCl excimer Laser operating at 308 nm), a tuneable Nd:YAG Laser, a CO₂ Laser, preferably at about 1 μm, an UV or IR source, an X-ray source, a sonar source or a heater or a combination of these.

In particular, when using a Laser system for providing the activation energy in the activation zone it is possible that the precursors are present in fluids, like gases and liquids as well as in other systems like sol/gel systems and in solids. For example, the carrier for the precursor molecule may be a gas or a liquid. Alternatively, the precursors may be present in a solid and may be subjected to the activation energy to produce nanoparticles. E.g. in case of catalysts, the precursors of the nanoparticles may be present in the carrier of the catalytic system, the catalyst itself or on the surface of the catalyst and the active ingredients in the form of nanoparticles may be produced in the carrier system by applying one or a combination of types of activation energy to the system.

In a solid, the precursor may be dissolved in the solid or part of the solid may be the precursor. E.g. the activation energy in combination with heat allows the precursor to diffuse and migrate and react to nanoparticles. The diffusion may be bulk diffusion or grain boundary diffusion in a polycrystalline solid such as for example polysilicon.

Gases useful as a gaseous carrier system are e.g. an inert gas, like argon, neon, krypton and xenon. If a carrier gas is needed, it should be neutral to the reaction or facilitate the reaction but not disturb it. Hydrogen for example is a gas, which is involved in Si particle generation from e.g. Dichlorosilane (SiH₂Cl₂),

SiH₂Cl₂+H₂←>Si+H₂+2HCL

where H₂ helps the Si-generation and can be used as a dilutand or carrier gas.

Depending on the chemistry, a liquid carrier system useful according to the present invention may be water, alcohols, solvents, acids, bases, oils, metals, polyimids, etc or mixtures thereof.

As precursors, all kinds of precursors may be used. Precursors in a gaseous system can be solids, liquids and gases. A solid precursor like TaCl₅ needs to be sublimated and transported either by its sublimation pressure or by a carrier gas neutral or helpful to the reaction. It could also be carried as dispersion or suspension into the gas system. A liquid precursor like TEOS may be vaporized and transported by its vapour pressure or by a carrier gas, which bubbles through it and is carried into the reactor. Obviously a gas precursor can be added through a conventional gas panel.

In a liquid system also gaseous, liquid and solid precursors can be used. A gas can simply be dissolved in a neutral or helping liquid, such as Ozone in water which generates H₂O₂, a strongly oxidizing agent. Equally N₂, CO₂, O₂ etc easily are dissolved in water. A liquid can simply be added to the liquid flow. A mixing procedure may be required. A solid must be dissolved in a neutral or helping carrier liquid, which is often done by adding a salt to a liquid. This solution can be added to the precursor flow. The production and the supply of the precursors to the activation zone may be effected by measures and means known in the art.

While this invention is not limited to certain precursors, in the table below here provided a list of the preferred precursors:

| Name | Abreviation | Formula |
|---|---|---|
| Trimethylaluminum | TMAl | (CH₃)₃Al |
| Triethylaluminum | TEAl | (C₂H₅)₃Al |
| Dimethylaluminum | DMAlH | (CH₃)₂AlH |
| Trimethylaminoalane | TMAA | AlH₃:NMe₃ |
| Triethylaminoalane | TEAA | AlH₃:NEt₃ |
| Diethylalane | | Et₂AlH |
| Ethyldimethylaminoalane | EDMAA | AlH₃:NMe₂Et |
| Arsine | | AsH₃ |
| Trimethylarsin | TMAs | (CH₃)₃As |
| Dimethylarsenic | DMAs | (CH₃)₂As |
| Triethylarsenic | TEAs | (C₂H₅)₃As |
| Dimethylarsenic | DEAs | (C₂H₅)₂AsH |
| Ethylarsine | E As | (C₂H₅)AsH₂ |
| Tributhylarsenic | TBAs | (C₄H₉)₃As |
| Phenilarsine | PhAsH₂ | (C₆H₅)AsH₂ |
| Trisdimethylaminoarsenic | TDMAAs | AsH₃:NMe₃ |
| Trimethylboron | TMB | (CH₃)₃B |
| Triethylboron | TEB | (C₂H₅)₃B |
| Trimethylborane | TMB | (CH₃)₃BO₃ |
| Triethylborane | TEB | (C₂H₅)₃BO₃ |
| Trimethylbismuth | TMBi | (CH₃)₃Bi |
| Triethylbismuth | TESi | (C₂H₅)₃Bi |
| Dimethylcadmium | DMCd | (CH₃)₂Cd |
| Diethylcadmium | DECd | (C₂H₅)₂Cd |
| Ethane | | (CH₃)₂ |
| Methane | | CH₄ |
| | | D₂ |
| Trimethylgalium | TMGa | (CH₃)₃Ga |
| Triethylgalium | TEGa | (C₂H₅)₂Ga |
| Triisobuthylgalium | TIBGa | (C₄H₉)₃Ga |
| Triisoprotylgalium | TIPGa | (C₃H₇)₃Ga |
| Tryimethylamine gallane | TMAG | GaH3:NMe₃ |
| | TMGa-TMP | |
| | TMGa-TEP | |
| | TMGa-TMAs | |
| | | H₂ |
| Tetramethylgermane | TrMGe | (CH₃)₄Ge |
| Tetraethylgermane | TrEGe | (C₂H₅)₄Ge |
| Tetrapropylgermane | TrPGe | (C₃H₇)₄Ge |
| Dimethylmercury | DMHg | (CH₃)₂Hg |
| Diethylcamercury | DEHg | (C₂H₅)₂Hg |
| di-n-propylmercury | DNPHg | (C₃H₆)₂Hg |
| di-i-propylmercury | DIPHg | (C₃H₆)₂Hg |
| di-n-butylmercury | DNBHg | (C4H |
| Trimethylindium | TMIn | (CH₃)₃In |
| Triethylindium | TEIn | (C₂H₅)₃In |
| ciclopentylindium | CpIn | C₅H₅In |
| Ethydimethylindium | EDMIn | EtMe₂In |
| Triisopropylindium | TIPIn | (C₃H₇)₃In |
| | TMIn-TMN | |
| | TMIn-TMP | |
| | TMIN-TEP | |
| | TMIn-TMAs | |
| Nitrogen | | N₂ |
| Ammonia | | NH₃ |
| Hydrazine | | N₂H₄ |
| | NMHy | |
| | 1,1 DMHy | |
| Phenylhydrazine | | N₂H₃(C₆H₅) |
| Diclyclopentadienylnickel | | (C₅H₅)₂Ni |
| Phosphin | | PH₃ |
| Trimethylphosphorus | TMP | (CH₃)₃P |
| Triethylphosphorus | TEP | (C₂H₅)₃P |
| Tributylphosphorus | TBP | |
| Isobutylphosphine | IBP | |
| Diethylphosphine | DEP | |
| Bisphophinoethane | BPE | |
| Bisphophinomethane | BPM | |
| Trisdimethylaminophosphorus | TDMAP | ((CH₃)₂N)₃P |
| Tertiarybutyldimethylaminophosphine | TBBDMAP | |
| Dimethylleid | DMPb | (CH₃)₂Pb |
| Tetramethylleid | TrMPb | (CH₃)₄Pb |
| Ethyltrimethylleid | EDMPb | EtMe₃Pb |
| Diethyldimethylleid | DEDMPb | Et₂Me₂Pb |
| Sulfure | | H₂S |
| Dimethylsulfur | DMS | (CH₃)₂S |
| Diethylsulfur | DES | (C₂H₅)₂S |
| | | C4H4S |
| | | C4H8S |
| Diisopropylsulfur | DIPS | |
| Methylmercaptan | MSH | CH₃SH |
| Trimethylantimony | TMSb | (CH₃)₃Sb |
| Triethylantimony | TESb | (C₂H₅)₃Sb |
| Triisopropilantimony | TIPSb | (iC₃H₇)₃Sb |
| | TIPSbH | |
| Tercbutyldimethylantimony | TBDMSb | |
| Dimethylaminoantimony | TDMASb | |
| | TVSb | |
| Selenon | | H₂Se |
| dimehylsellenium | DMSe | (CH₃)₂Se |
| Diehylsellenium | DESe | |
| Selenophone | cyclo | C₄H₈Se |
| Metilselenon | MSeH | CH₃SeH |
| Diisopropylsellenim | DIPSe | (iC₃H₇)₃Se |
| Tributylaminosellenium | TBASe | |
| Silane | | SiH₄ |
| Tetramethyl silane | TMS | Si(CH₃)₄ |
| Diclorosilane | DCS | SiCl₂H₂ |
| Methyl stannane | MSn | CH₃SnH₃ |
| Dimethyl stannane | DMSn | (CH₃)₂SnH₂ |
| Trimethylstannane | TMSn | (CH₃)₃Sn |
| Tetramethylstannane | TrMSn | (CH₃)₄Sn |
| | | H₂Te |
| dimethyltelluride | DMTe | (CH₃)₂Te |
| dimethylditelluride | DMDTe | |
| diethyltelluride | DETe | (C₂H₅)₂Te |
| 2,5-dihydrotellurohene | DHTe | C₄H₆Te |
| diisopropyltelluride | DIPTe | (iC₃H₇)₃Te |
| ditertiarybutyltelluride | DTBTe | |
| di-n-propyltelluride | DNPTe | |
| diallyltelluride | DATe | |
| | DNBTe | |
| Trimethyltallium | TMTl | (CH₃)₃Tl |
| Triethyltallium | TETl | (C₂H₅)₃Tl |
| Dimethylzinc | DMZn | (CH₃)₂Zn |
| Diethylzinc | DEZn | (C₂H₅)₂Zn |

For example the ethyl and methyl groups of some of these precursors highly absorb the wavelengths of the CO₂ Lasers. In one embodiment of this invention, heat will bring the precursors close to their reaction temperature. It is an achievable advantage of this embodiment of the invention that a small amount of additional activation energy delivered by light/Laser in the activation zone will let the precursors overcome their activation energy barrier and start the nucleation and growth.

The nanoparticles obtained according to the present invention may be deposited directly without additional classification of the nanoparticles on a variety of substrates including both organic and inorganic substrates. The deposition may be effected by passing the stream of nanoparticles over the substrate and allowing the nanoparticles to become affixed to the substrate by, e.g. electrostatic attraction or condensation. The substrate may be relatively movable to the stream, thus, building a thin layer, which may be a single layer or multiple layers, on the substrate.

With the method according to the present invention, it is possible to make the process of classifying the resulting nanoparticles to obtain nanoparticles of a defined and narrow size distribution redundant, thus, saving time and money.

In this connection it is noted that the methods as described herein may require total and partial pressures other than atmospheric pressure. The nanoparticles produced according to the present invention may be collected and/or generated on surfaces, substrates, collectors, cold traps, in liquids, in suspension, in solids and so forth.

The activation energy may be supplied by any one of the sources described above, or a combination thereof.

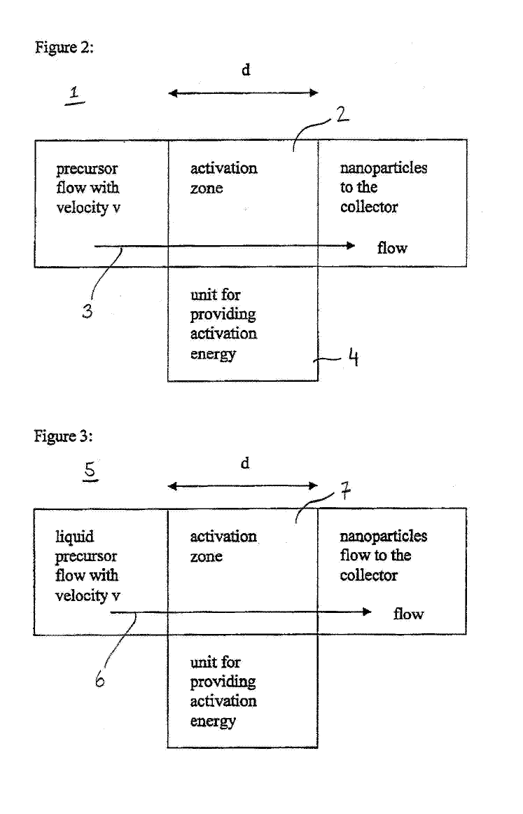

In the following, the present invention will be described further making reference to the flow charts shown in FIGS. 2 to 9.

Firstly, a system comprising a chemical vapor synthesis (CVS) of nanoparticles with a narrow size distribution is described.

Nanoparticles can be generated from the gas phase by providing one or more precursors in the gas phase with the necessary activation energy by means of one or a combination of several types of activation energy, thus, a chemical reaction is induced resulting in the nucleation and growth of the desired nanoparticles.

According to the method of the present invention, the size of the particles is limited by determining the time during which the precursors are exposed to the one ore more types of activation energy for the nucleation and growth of the nanoparticles. In particular, in the CVS system the precursor gas mixture flows with a predetermined velocity through a reaction chamber comprising the activation zone, where the one or more types of activation energy are provided. The one or more types of activation energy are only provided during the predetermined time when the precursors flow through the activation zone, thus, the limited time as well as the strength of the activation energy, the kind or combination of activation energies (for example the photon energy determined by the wavelength in combination with heat), the field strength of the electromagnetic waves and temperature, determine the size of the nanoparticles. It is clear that also other parameters, like the concentration of the particles, reactor shape, type of flow, total pressure etc. must be kept constant. FIG. 2 shows a schematic of the flow chart for a method according to the present invention. In particular, FIG. 2 shows a system 1 containing one activation zone 2 and having a precursor flow 3 with a constant velocity and constant concentration of the precursor using a fluidic carrier system. The activation energy is supplied to the precursor in the activation zone having a constant length d. In FIG. 2, the unit of providing the activation energy 4 is a Laser system. Of course any other system as described herein is possible.

Another embodiment for the so called method of the chemical liquid synthesis (CLS) 5 of nanoparticles with a narrow size distribution which is very similar to the CVS method described above is shown in FIG. 3. According to the CLS method, the precursor is present in a liquid carrier system. Appropriate liquid carrier systems are described above. The liquids containing the precursors flow 6 with a predetermined velocity through the reaction chamber containing the activation zone 7 where the activation energy is provided to the system. Thus, the activation energy for the nucleation and growth is only provided during the time t when the precursors pass the activation zone 7. Hence, the limited time in combination with the substantially uniform strength of the activation energy determine the size of the nanoparticles. Of course other parameters as listed above have to be kept constant.

In one embodiment of this invention, where the flow velocity across the flow diameter cannot be kept constant, such as in a laminar flow system, the laminar flow profile can be compensated by the shape of the activation energy or the shape of one of the activation energies. Some of the profiles in a Chemical Vapor Synthesis (CVS) or a Chemical Liquid Synthesis (CLS) Systems with special energy density distribution are described here.

The system as described here, depends on contributing activation energy, e.g. a combination of heat EM wave energy, to a certain volume element over a certain time. In a laminar flow system the flow velocity profile is parabolic. If a uniform energy density is applied for example as activation energy, the slow peripheral flow would experience more energy than the faster center flow during the transition of a certain volume element.

Various methods to overcome this energy discrepancy are described in the following examples:

### Example 1

The flow 8 is through a straight tube 9, and the activation energies are applied by heat through a multi zone oven 10 and light/Laser radiation parallel or antiparallel to the flow, e.g. provided by a Laser 11 as shown in the schematic FIG. 8. The precursors, e.g. Ga(CH₃)₃, In(CH₃)₃, AsH₃ or AsH₂ (and/or other precursors) and Ar or H₂ are introduced via a gas panel and gas inlet 12 flanged to one end of the straight tube 9, from the side into the straight tube 9. At the other side of the straight tube 9, the nanoparticles leave the tube through a valve 13 flanged to this end of the straight tube 9 to be collected in a collector 14. The gas flow 8 can leave the tube via a bypass 15 flanged (see flanges 28) to the same end of the straight tube 9 to establish steady state conditions before the particles are harvested in the collector 14. The remaining gas can leave via a pump system 16 and a scrubber exhaust 17. Of course, flanges 28 can be replaces by welds or any other suitable means of suitable connestion.

The antiparallel direction of the Laser radiation 18, as shown in FIG. 8 is preferred. This allows the dimensions to be chosen such, that the activation energy is absorbed by the media before the turbulence and disturbance of the uniform laminar flow pattern of the first turn becomes a factor: By the time the precursors and the particles reach the Laser-side turn they are depleted, so that the effect of the turbulent disturbance at this end is minimized. A beam analyzer 18 can be provided at the end of the straight tube 9 opposite to the end where the Laser 11 is located to analyze the beam shape and intensity and control the Laser 11 accordingly. A vertical flow system, i.e. a system where the straight tube 9 is arranged parallel to the direction of gravity, is preferred but not required in order to minimize turbulence vertical to the flow direction caused by non-uniform heating of the tube 9. The Laser intensity is shaped such that the intensity is parabolic or close to parabolic with the highest intensity in the center of the tube 9, where the flow 8 is highest and the lowest intensity at the tube periphery, where the flow 8 is slowest. Many Lasers 11 have a Gaussian profile which is close enough to a parabolic profile if one blends out the edge of the Laser 11. So it might not be necessary to employ expensive optics to have an almost parabolic intensity profile of the Laser 11.

FIG. 8 shows the schematic of a straight tube CVS or CLS system with a parabolic beam intensity distribution.

In this system the parabolic flow profile can be compensated for by shaping the energy density profile of the beam 18 parabolic as well. Since the loss of laminar flow at non-uniform tubing shapes such as the tube inlet and exhaust can result in turbulent flow mostly downstream from the perturbation, it may be advantageous to radiate the Laser energy upstream as shown in FIG. 8. In this case the flow perturbation at the exhaust end exposed to the beam is of relatively short duration and the result of the perturbation after the inlet may not be significant, since the Laser energy there is reduced by absorption and due to Beers law.

### Example 2

Again the flow is through a straight tube 9 and the activation energies applied by the combination of heat through a one or multi zone oven 10 and concentric light/Laser radiation from a Laser 11 as shown in the schematic in FIG. 9. However this time the Laser beam 18 is uniform in radiation density across its diameter and focused towards the middle of the tube length. Since the energy density per area is proportional to the square of the beam radius: r² and this beam radius is proportional to the position along the tube x, the activation energy application due to the light/Laser 11 over the volume of a certain length is also parabolic with respect to the beam radius.

FIG. 9 shows the schematic of a straight tube CVS or CLS system with a focused beam 18.

Again because of turbulences downstream from the inlet and the exhaust of the straight tube 9, it may be advantageous to radiate upstream as shown in FIG. 8. In this case the flow disturbance at the exhaust end of the tube is experienced relatively short by the beam 18 and the flow perturbation at the inlet end of the tube 9 receives only a reduced energy due to beam absorption. A nice feature of the diminishing and increasing beam 18 before and after the waist minimum is a partial compensation of the beam 18 over the volume due to beam absorption. Also a vertical configuration of the tube 18, i.e. a configuration where the tube 9 is arranged parallel to the direction of gravity, reduces the turbulence perpendicular to the flow due to heating nonuniformities.

### Example 3

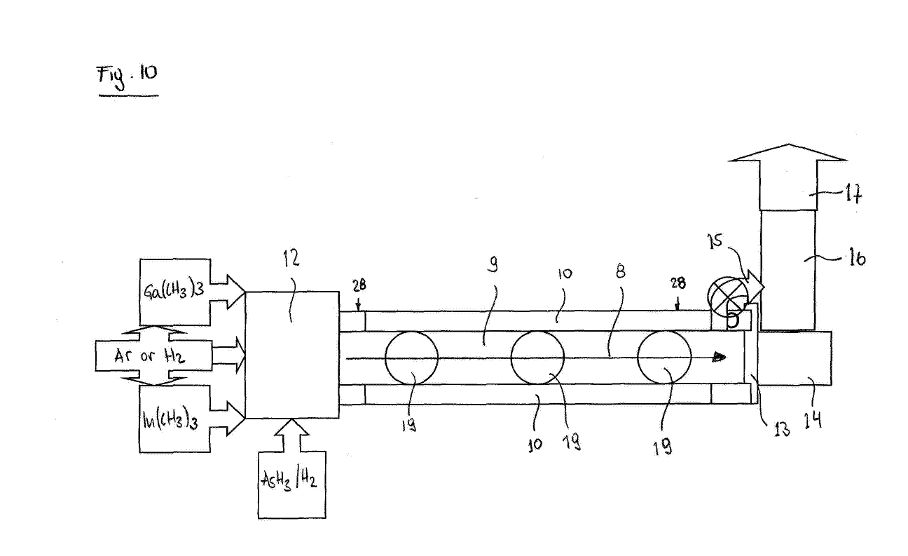

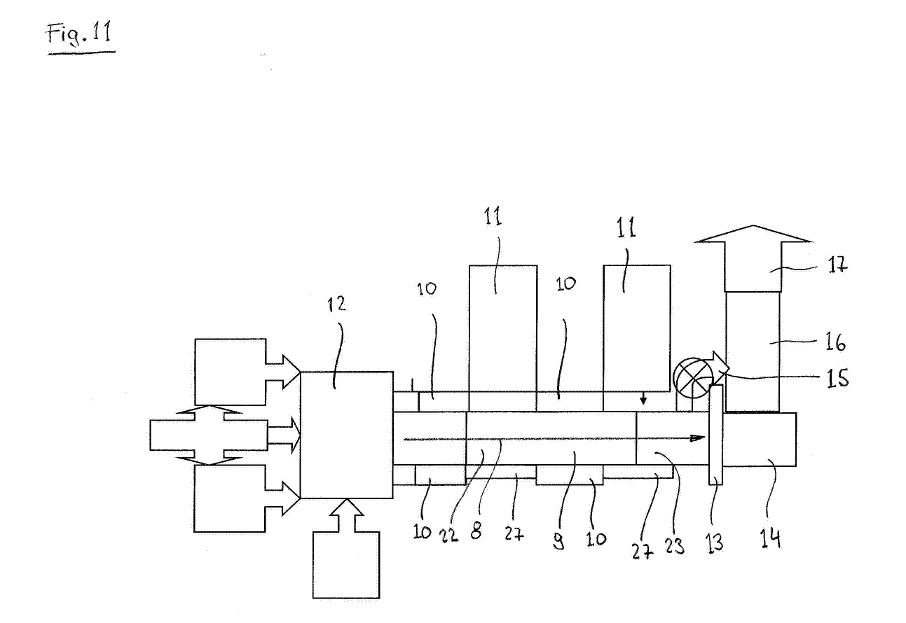

The parabolic shape near the base point of the paraboloid can be very well approximated by a sphere. In case of laminar flow 8 with a parabolic flow profile and a plasma 19 generated by RF or MW plasma, a spherical plasma 19 can be generated for example by resonance. This approach is very limited in dimensions, since in most countries only few frequencies (f=13.56 MHz, 0.915 GHz or 2.45 GHz) are permitted for such commercial applications. This method, shown in a possible scheme in FIG. 10, is not a perfect compensation but a fairly good compensation of the energy distribution for the laminar flow profile. As shown in FIG. 10 one is not limited to one plasma 19 application but can use several plasmas 19 in sequence in close proximity or separated by some space.

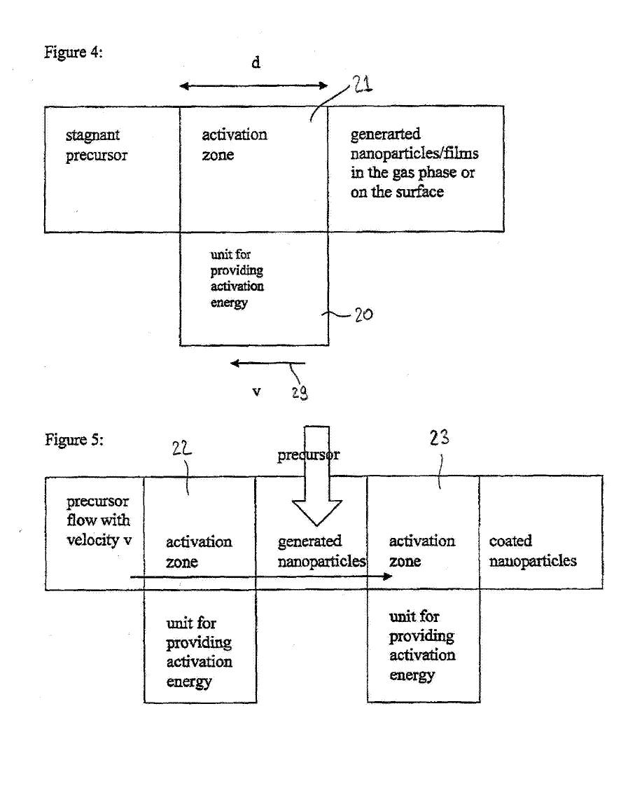

A further embodiment of the CVS and the CLS system is shown in FIG. 4.

Here, the carrier system containing the precursors is stagnant while the unit for providing the one of the activation energies 20, for example, a Laser sweeps 29 with velocity v through the gas or liquid or solid carrier system, respectively. The other energy could be heat since a certain temperature of the gas or liquid or solid containing the precursors contributes to the repeatability of the synthesis results. The reaction time t of the precursor is limited to a predetermined zone where the activation energy is provided. Again, the limited time and the strength and time of the activation energy determine the size and type of the nanoparticles. Additional heat may be required to mobilize the precursors, e.g. by diffusion. The same is true for the CLS system as shown in FIG. 4. Again the unit for providing the activation energy, for example a Laser 20, sweeps over the liquid carrier system, the sol/gel system or the solid carrier system which is stagnant or which flow with a much lower velocity than the sweep velocity. As described above, the reaction time is limited to the activation zone 21 and thus, a predetermined amount of activation energy can be applied for a predetermined time, thus, resulting in nanoparticles having a narrow particle size distribution.

Another embodiment of the invention is outlined in the following and allows two or more different reactions of the nanoparticles. Typically, in the first reaction the nucleation and growth takes places while in the second reaction a coating to the particles is applied. In further reaction step(s), coating of a different compound may be affected. These two or more different reactions can follow one another with two or more different and distinct activation energies applied subsequent in time to the initial nucleation and growth sweep/zone of the nanoparticle. In particular, as shown in FIG. 5, in the first activation zone 22 nanoparticles are formed from the precursors. Said nanoparticles are supplied with additional precursors which may be identical or different to the precursors of step/reaction 1. Subsequently the mixture passes the second activation zone 23 to coat the nanoparticles of step 1 with the coating produced by the precursors and activation energy/ies. The electromagnetic wave providing the activation energy for the second activation zone may have the same activation energy or may have a different and distinct activation energy which causes a different reaction. Thus, a nucleation in the first step and a coating in the second step can be achieved. Also the temperature in the first and second activation zone may be the same or different.

The precursors for coating may be present in the initial system entering the first activation zone 22 or may be supplied to the nanoparticles generated in the first activation zone 22 not containing the initial precursors. Of course it is possible to combine two or more activation zones 22, 23.

In case of precursors or nanoparticles fixed in or on a layer or in or on a solid (chemical solid synthesis CSS) it is possible to perform pattern writing and the like.

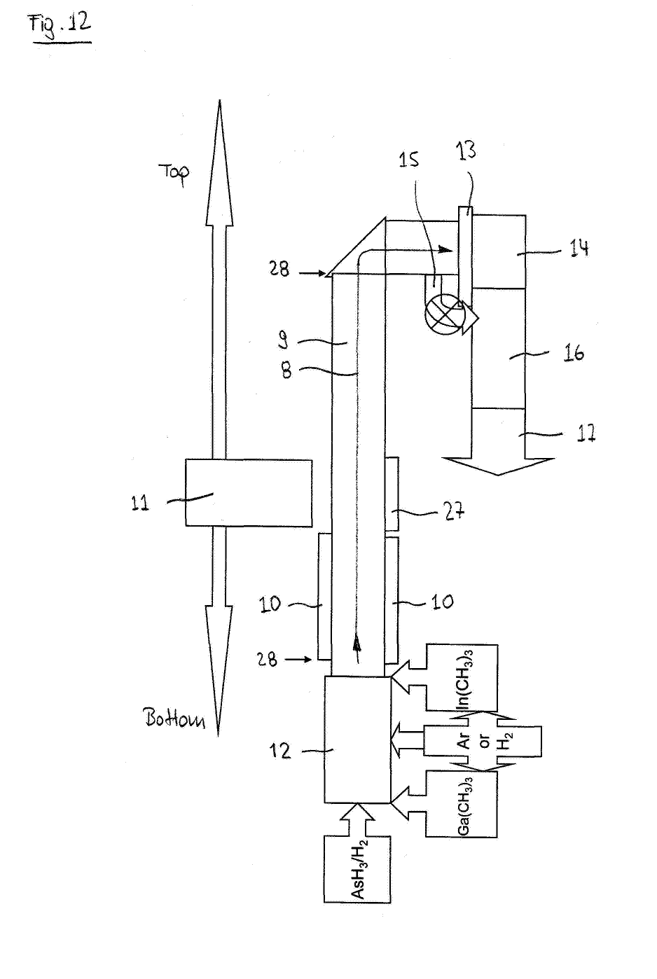

FIG. 11 shows another example of a system with two activation zones 22, 23. In this example, each activation zone is equipped with a pulsed Laser 11. Below, the application of pulsed lasers is explained in more detail.

With the methods described above, it is also possible to deposit nanoparticles on a surface or in a solid or microporous material like carrier systems for catalysts.

In case of using a system where the unit for providing the activation energy sweeps over the precursor containing system which may be a fluid or a solid system, the sweep velocity and the dimension of the activation zone as well as the kind of activation energy will determine the size and/or thickness of the nanoparticles and the coating thereof.

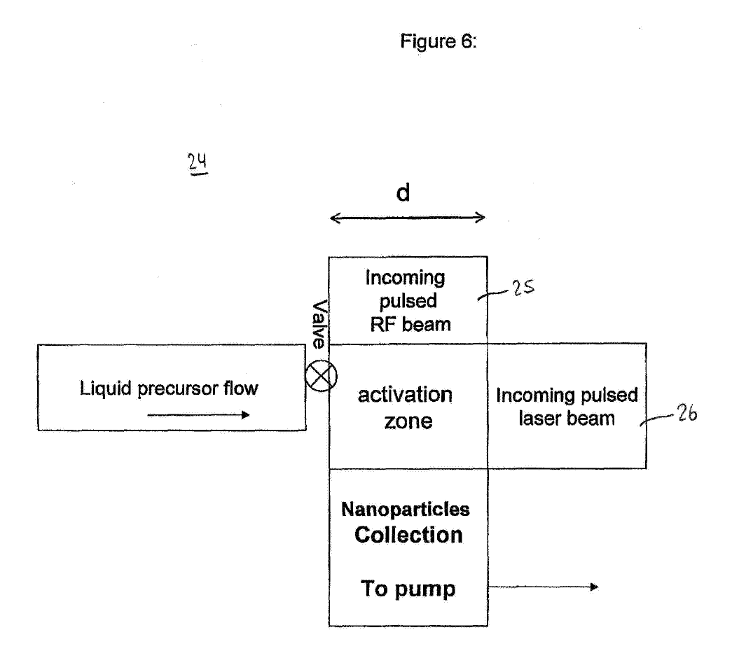

A further embodiment of the present invention is shown in FIG. 6. FIG. 6 is a flow chart showing a system 24 for a pulsed nanoparticle synthesis. Various methods lend themselves to pulse the activation energy for a predetermined time and with a predetermined energy in gas, liquid, gel/sol system, solid or on the surface. The time and amount of activation energy which is controlled by the number and period of pulses determine the nucleation and growth and, thus, the size of the nanoparticles. Further, as shown in FIG. 6, it is possible to use two different systems to pulse the activation energy. In FIG. 6 a RF beam 25 is provided and, additionally, a pulsed Laser beam 26. The pulses may be applied at the same time or may be applied sequentially. If required, additional heat or/and sonar energy may be applied to promote diffusion.

Generally, in gas systems, the chemical composition and the partial pressure of the precursors in the gas determine the chemical composition and size of the nanoparticles and their coatings. In liquids, the chemical composition and the concentration of the precursor in the liquid determine the chemical composition and the size of the nanoparticles and their coatings. In solids or in sol/gel systems the chemical composition, doping with the precursors and diffusivity in the solid or the sol/gel determine the chemistry and the size of the nanoparticles and their coatings.

The following may be important in a pulsed nanoparticle synthesis system in case of the combination of heat and pulsed (Laser-) light as activation energies, as e.g. shown in FIGS. 11 to 14:

If the flow velocity (liquid or gas) varies across the diameter, as is the case in a laminar flow profile or a turbulent flow, the (Laser-) light pulse/s applied (nearly) perpendicular to the physical flow 8, as shown in FIGS. 11 and 12, has to be so short in time, that the physical transport caused by the flow 8 is negligible during the pulse time. This means the transport during the pulse time should not exceed 1/10 of the (Laser-) light width in the direction of the fastest flow. In such a case of perpendicular radiation the tubing 9 must be narrow enough so that the absorption of the (Laser-) light according to Beer's Law is negligible or mirrors 27, reflective walls or multiple light sources need to be considered. This prevents volume elements and nanoparticles to be exposed to substantially different total amounts of activation energy.

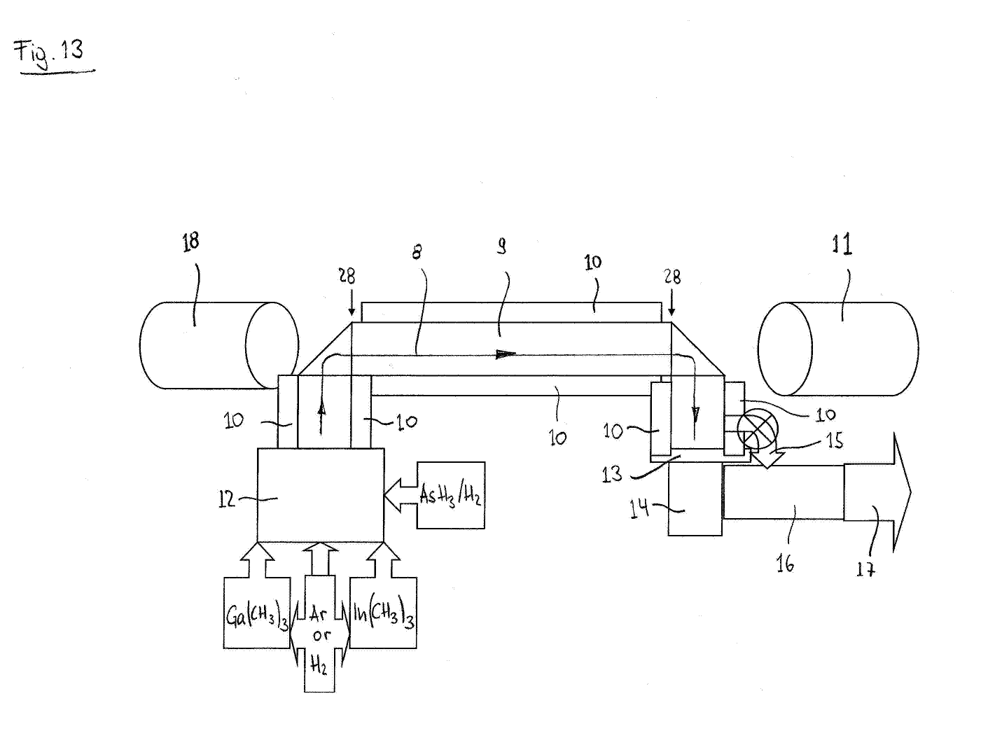

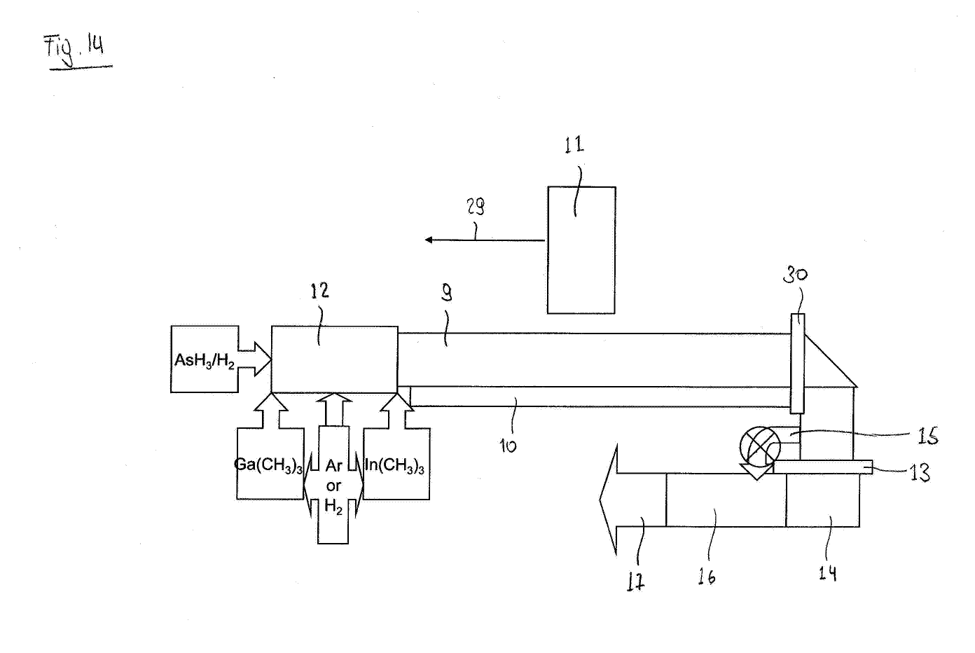

If the flow varies across the diameter, as e.g. is the case in a laminar flow profile, the (Laser-) light pulse applied parallel or antiparallel to the physical flow 8 of the precursors, as shown in FIG. 13, may have to be shaped, as earlier described to compensate for the variable flow speed. The time between the pulses or pulse sequence has to be such, that most or better all the precursor and nanoparticles have cleared the activation/reactor zone, before a new (Laser-) light pulse or pulse sequence is applied. This prevents volume elements and nanoparticles generated in them from experiencing the activation energy twice or more times and from reaching therefore to a different size depending on their location when the pulse/s or pulse sequence starts. In such as system a mirror at one end or a 2^{nd} (Laser-)light source may be required to compensate for absorption of the (Laser-)light along its path as indicated by Beers Law.

In a system where the fluid (gas, liquid or solid) is at rest in its system, as shown in FIG. 14, and the type of activation energies are heat and pulsed (Laser-)light or pulse sequences of (Laser-)light applied to it, care has to be taken so that light absorption is compensated by a reflective system or multiple light sources, in order for all volume elements and nanoparticles to be exposed to the same amount of activation energy. In the example of FIG. 14, a flange 30 at the end of the tube 9 can be provided, which connects the tubing 9 to a possible particle collector.

As indicated before, the method according to the present invention allows the production of nanoparticles in gas, liquid, sol/gel and solid systems. This is particularly true when using a Laser or other type of photon activation.

When using a Laser system to provide the activation energy, it may be preferable that the electromagnetic waves are in the direction of the flow of the precursors. Of course it is possible that the angle of incidence is vertical to the direction of flow or when sweeping the unit for providing the action energy, is vertical to the layer. Other angles are also possible as long as the amount of activation energy over the time when passing the activation zone is substantially the same for the precursors.

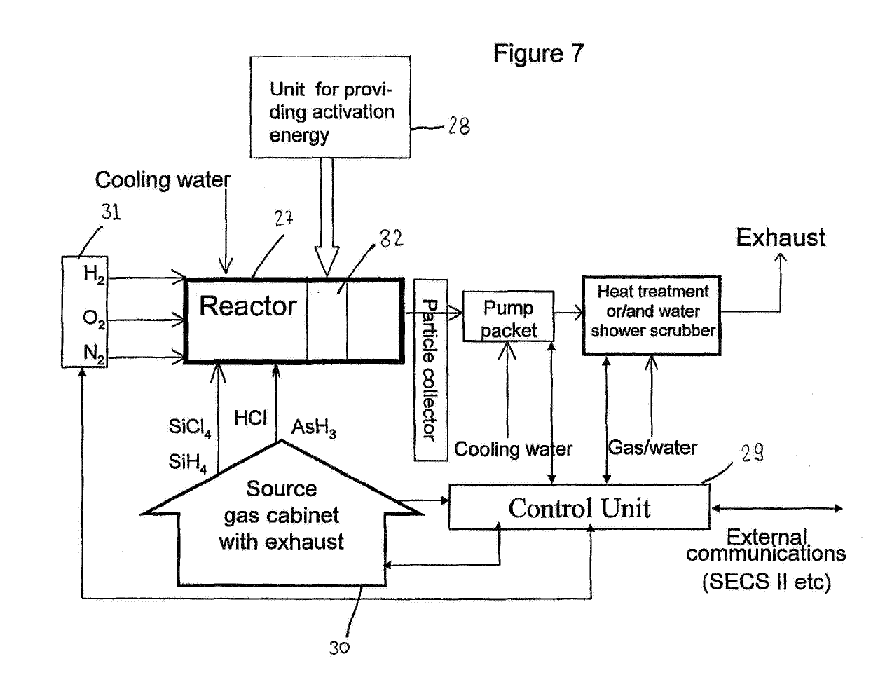

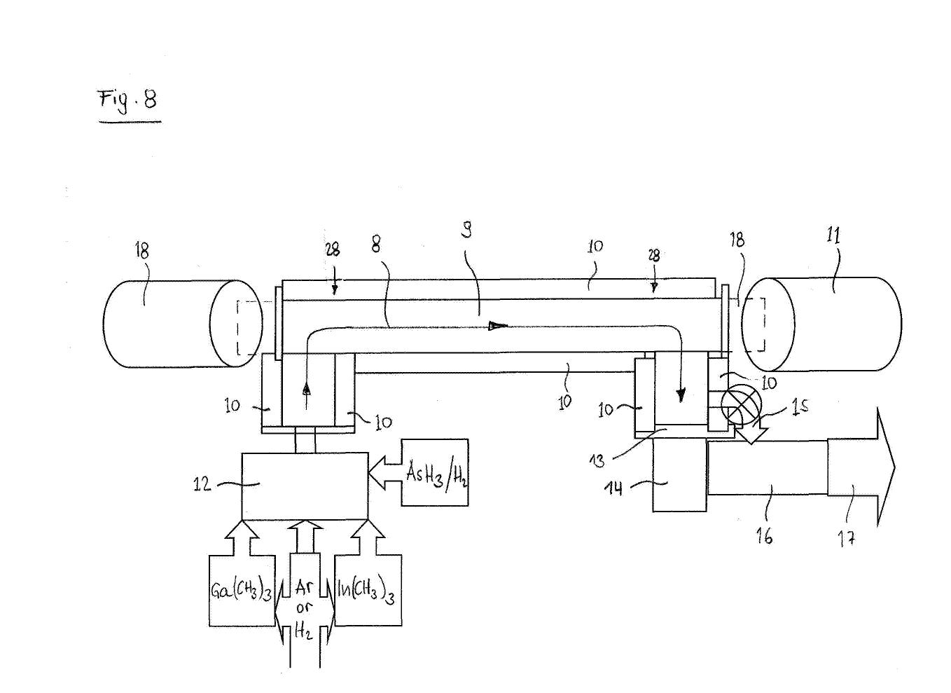

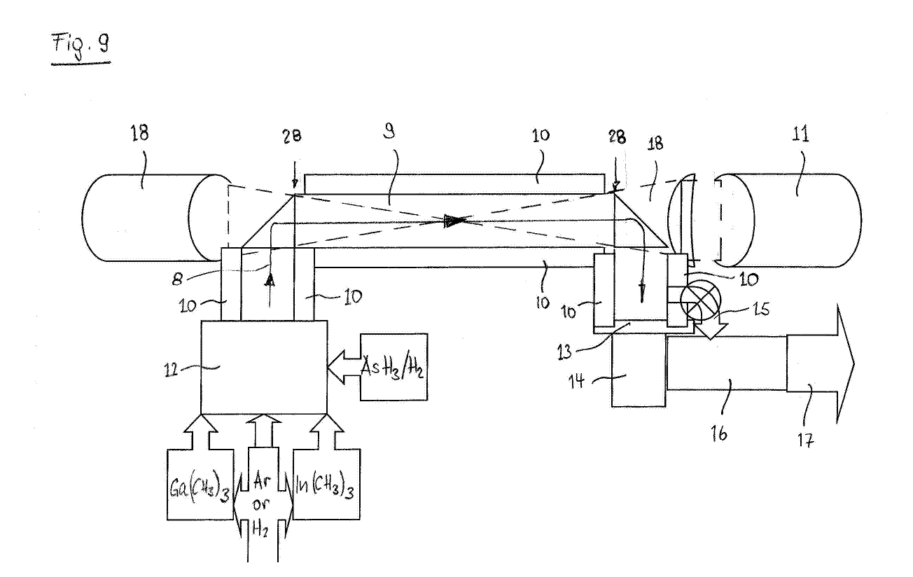

FIG. 7 shows a device according to the present invention. The device comprises the reactor 27 containing the activation zone 32, the activation unit for providing the activation energy 28 and the control unit 29. The control unit 29 controls the supply of the precursor material, e.g. the concentration of the precursor in the system and the velocity of the flow through the activation zone of the reactor 27. In addition, the control unit 29 regulates the amount and the type of activation energy introduced into the activation zone 32. Further, the control unit 29 may regulate the amount of fluid provided as the carrier system. Optionally, the control unit 29 determines the particle size of the generated nanoparticles and controls the particle size distribution and the particle size itself. As shown in FIG. 7, the precursors might be provided from a source gas cabinet 30. Further, the device according to the present invention may comprise a unit to provide carrier fluid, like carrier gas 31.

In some instances, the nanoparticles produced in accordance with the method provided herein may have an average diameter of no more than about 1000 nm, preferably nanoparticles having an average diameter of no more than about 100 nm, preferably nanoparticles having an average diameter of no more than about 50 nm, which includes nanoparticles having an average diameter of no more than about 30 nm, further includes nanoparticles having an average diameter of no more than about 10 nm, still further includes nanoparticles having an average diameter of no more than about 5 nm and even further includes nanoparticles having an average diameter of no more than about 2 nm.

The type of nanoparticles which may be produced with the method according to the present invention encompasses metal nanoparticles, metal alloy nanoparticles, metal oxide nanoparticles, metal nitride nanoparticles, semiconductor nanoparticles, ceramic nanoparticles, nanodots, dielectric nanoparticles, superconducting nanoparticles etc. and all types of coated nanoparticles.

As described above, the size of the nanoparticles produced in accordance with the method according to the present invention will depend on, at least, the residence time of the particles in the activation zone, which in turn depends on the flow rate of the precursor.

1. A method for preparing nanoparticles having a narrow size distribution comprising the steps of:
flowing precursors through an activation zone of a reactor or moving a unit which provides activation energy to said activation zone of said reactor; and
activating said precursors in said activation zone of said reactor with an amount of an activation energy for a predetermined time at a predetermined concentration of the precursors, wherein amount of activation energy over the predetermined time when said precursors pass through the activation zone is substantially the same for all of the precursors, said activating step forming nanoparticles from said precursors.

2. The method according to claim 1, wherein the amount of activation energy is introduced into the activation zone at least partly with electromagnetic waves.

3. The method according to claim 1, wherein the amount activation energy is applied by a single type of activation energy.

4. The method according to claim 1, wherein the amount activation energy is applied by combining at least two different types of activation energy.

5. The method according to claim 4, wherein the at least two different types of activation energy are applied simultaneously.

6. The method according to claim 2, wherein an energy density vertical to the electromagnetic waves is substantially uniform.

7. The method according to claim 1, wherein a spatial power density distribution of at least one type of activation energy in the activation zone is non-uniform, and to at least partially compensates for a non-uniform spatial distribution of flow velocities of the precursors.

8. The method according to claim 1 wherein the activation zone is essentially tubular having a center and a length, and said non-uniform spatial distribution of the flow velocities of precursors is essentially a parabolic function of a distance from the center of the activation zone, and the spatial power density distribution of at least one type of activation energy integrated over the length of the activation zone is essentially a parabolic, Gaussian, or spherical function of a distance from the center of the activation zone, and to at least partially compensates for a non-uniform spatial distribution of the flow velocities of the precursors.

9. The method according to claim 1, wherein at least part of the amount of activation energy is applied by means of a beam of electromagnetic waves that propagate in a direction essentially parallel or anti-parallel to a direction of flow of the precursors.

10. The method according to claim 1, wherein at least part of the amount of activation energy is applied by means of a beam of electromagnetic waves having a parabolic, Gaussian, or spherical intensity profile in a plane perpendicular to a direction of propagation of said nanoparticles.

11. The method according to claim 1, wherein at least part of the amount of activation energy is applied by means of a beam of electromagnetic waves being focused on a center line of the activation zone.

12. The method according claim 1, wherein at least part of the amount of activation energy is applied by means of a spherical plasma in the activation zone.

13. The method according to claim 1, wherein at least one of flow velocities and a mean free path of the precursors is chosen so that the precursors diffuse far enough while in the activation zone to at least partially compensate for a non-uniform spatial distribution of the flow velocities of the precursors.

14. The method according to claim 1, wherein a ratio of a wave length of the activation energy to a dimension/width of the activation zone is at least of the order of the mean free path of the atoms, molecules, or composite of a fluid in which the precursors are supplied.

15. The method according to claim 2, wherein the type of the electromagnetic waves for providing the activation energy is selected from the group of RF, MW, IR, visible light, UV, Laser or other light sources, or obtained by electric discharge, radioactive radiation, heat or sonar energy or a combination of at least two of said types of energies.

16. The method according to claim 1 wherein a type or types of activation energy in the activation zone are selected from the group of RF, MW, IR, RF plasma, MW plasma, IR plasma, thermal plasma, heat, photon absorption, plasma by electronic discharge or radioactive radiation or sonar energy or a combination thereof.

17. The method according to claim 1, wherein a type of activation energy used in said activating step is photon absorption through light and said light is applied from one or more sides to the activation zone.

18. The method according to claim 1, wherein at least one type of activation energy is pulsed for a predetermined time and a predetermined energy in the activation zone.

19. The method according to claim 18, wherein the duration of the pulse of activation energy is chosen so that a transport of the precursors during the pulse time does not exceed 1/10 of a width of a part of the activation zone affected by the pulse of activation energy, the width being measured in a direction of a fastest flow of precursors.

20. The method according to claim 1,
wherein the unit for providing the activation energy is moved to at least one of an area or volume of said reactor which contains the precursors.

21. The method according to claim 20, wherein the precursors are stagnant in the reactor and the unit for providing at least one of the activation energies is moved with a constant velocity and constant width through the stagnant layer of precursors.

22. The method according to claim 1, wherein the precursors are present in a gas phase.

23. The method according to claim 1, wherein the precursors are present in a liquid phase.

24. The method according to claim 1, wherein the precursors are present in a solid phase.

25. The method according to claim 1, further comprising the step of subjecting said nanoparticles to a second activation zone with sufficient energy for applying coatings to the nanoparticles.

26. The method according to claim 25, further comprising the step of supplying additional, optionally different precursors downstream from the activation zone and upstream of the second activation zone to the nanoparticles generated in the activation zone.

27. A device for producing nanoparticles, comprising;
an activation unit for providing activation energy,
at least one reactor having at least one activation zone, and
a control unit for controlling one or more of the group of
the activation energy,
pressure in the at least one reactor,
temperature,
flow of precursors through said at least one activation zone,
concentration of the precursors, and reaction time,
said control unit controlling the provision of an amount of activation energy over time when the precursors pass the activation zone such that the amount of activation energy over time is substantially the same for the precursors.

28. The device according to claim 27, wherein the activation unit provides at least two types of activation energy and the control unit controls the application of these types of activation energy.

29. The device according to claim 27 wherein said at least one activation zone comprises at least two activation zones, including a first activation zone and a second activation zone, producing coated nanoparticles.

30. The device according to claim 29, further comprising a supply arranged downstream of the first activation zone and upstream of the second activation zone for supplying precursor for coating nanoparticles.

31. The method according to claim 4, wherein the at least two different types of activation energy are applied sequentially.
